(19) United States
(12) Patent Application Publication
(10) Pub. No.: US 2022/0059862 A1
(43) Pub. Date: Feb. 24, 2022

(54) COMPRESSION METHOD FOR SOLID OXIDE FUEL CELL STACKS

(71) Applicant: PHILLIPS 66 COMPANY, Houston, TX (US)

(72) Inventors: Mingfei Liu, Bartlesville, OK (US); Ying Liu, Bartlesville, OK (US); Mark Jensen, Bartlesville, TX (US)

(73) Assignee: PHILLIPS 66 COMPANY, HOUSTON, TX (US)

(21) Appl. No.: 17/394,524

(22) Filed: Aug. 5, 2021

Related U.S. Application Data
(60) Provisional application No. 63/068,191, filed on Aug. 20, 2020.

(51) Int. Cl. H01M 8/248

(52) U.S. Cl. CPC H01M 8/248; H01M 4/9025

(57) ABSTRACT

A system for a solid oxide fuel cell stack disposed between and in contact with a fixed top compression plate and a movable compression plate. At least one tension rod can be inserted through an opening on a movable locking plate, wherein the top end of the tension rod is connected to the bottom of the movable compression plate and the bottom end of the tension rod is connected to a fixed bottom compression plate. At least one nut can be used in conjunction each tension rod and disposed below the movable locking plate to secure the movable locking plate in position. Additionally, at least one spring can be disposed around the at least one tension rod and connected to the bottom of the movable compression plate and the top of the fixed bottom compression plate. Finally, at least one pneumatic cylinder can be in contact with the bottom of the movable locking plate and the fixed bottom compression plate.

### CROSS-REFERENCE TO RELATED APPLICATIONS

None.

### STATEMENT REGARDING FEDERALLY SPONSORED RESEARCH OR DEVELOPMENT

None.

### FIELD OF THE INVENTION

This invention relates to a method for compressing a solid oxide fuel cell stack.

### BACKGROUND OF THE INVENTION

A solid oxide fuel cell (SOFC) stack can be subjected to various interruptions that can prevent or reduce electricity from being generated. One of those interruptions can be cell(s) cracking, which is usually a result of uneven stack pressure in a SOFC system exceeding the strength of the SOFC cells. Another interruption that can occur is the leaking of gases through compressive seals.

In conventional SOFC stack designs based on simple mechanics such as springs, pressure will increase with temperature-caused expansion or decrease with spring relaxation due to a linear correlation between spring pressure and spring displacement. At some point, the cell strength may deteriorate to the stress placed on the cells resulting in cell cracking and thus stack failure. In other cases, the cells may loss electrical contact or good sealing condition due to compression pressure loss/decrease. The stress placed on the springs is due to the expansion and contraction caused by the high temperatures and pressures required for SOFCs to operate.

There exists a need for a SOFC stack design that is able to handle the expansion and contraction due to the high temperatures and high pressures required from SOFCs to operate.

BRIEF SUMMARY OF THE DISCLOSURE

A system for a solid oxide fuel cell stack disposed between and in contact with a fixed top compression plate and a movable compression plate. At least one tension rod can be inserted through an opening on a movable locking plate, wherein the top end of the tension rod is connected to the bottom of the movable compression plate and the bottom end of the tension rod is connected to a fixed bottom compression plate. At least one nut can be used in conjunction each tension rod and disposed below the movable locking plate to secure the movable locking plate in position. Additionally, at least one spring can be disposed around the at least one tension rod and connected to the bottom of the movable compression plate and the top of the fixed bottom compression plate. Finally, at least one pneumatic cylinder can be in contact with the bottom of the movable locking plate and the fixed bottom compression plate.

A system for a solid oxide fuel cell stack disposed between and in contact with a fixed top compression plate and a movable compression plate. a solid oxide fuel cell stack disposed between and in contact with a fixed top compression plate and a movable compression plate. In this system, four tension rods can be inserted through four separate openings on a movable locking plate, wherein the four separate openings are located on the left front side of the movable locking plate, the left back side of the movable locking plate, the right front side of the movable locking plate, and the right back side of the movable locking plate and wherein the four tension rods are connected to the bottom of the movable compression plate and each bottom end of the four tension rods are connected to a fixed bottom compression plate. At least one nut can be used in conjunction with each tension rod and disposed below the movable locking plate to secure the movable locking plate in position. At least one spring can be disposed around each tension rod and connected to the bottom of the movable compression plate and the bottom of the fixed bottom compression plate. At least one pneumatic cylinder can be in contact with the bottom of the movable locking plate and the fixed bottom compression plate. In this embodiment, the fixed top compression plate and the fixed bottom compression plate can be connected with at least four rods, wherein the first rod is in contact with the bottom left front side of the fixed top compression plate and the top left front side of the fixed bottom compression plate, the second rod is in contact with the bottom right front side of the fixed top compression plate and the top right front side of the fixed bottom compression plate, the third rod is in contact with the bottom left back side of the fixed top compression plate and the top left back side of the fixed bottom compression plate, the fourth rod is in contact with the bottom right back side of the fixed top compression plate and the top right back side of the fixed bottom compression plate.

### BRIEF DESCRIPTION OF THE DRAWINGS

A more complete understanding of the present invention and benefits thereof may be acquired by referring to the following description taken in conjunction with the accompanying drawings in which:

FIG. 1 depicts a system for a solid oxide fuel cell stack.

FIG. 2 depicts a depicts a cross sectional view of the system for a solid oxide fuel cell stack.

FIG. 3 depicts a depicts a cross sectional view of the system for a solid oxide fuel cell stack.

FIG. 4 depicts an alternate system for a solid oxide fuel cell stack.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The following examples of certain embodiments of the invention are given. Each example is provided by way of explanation of the invention, one of many embodiments of the invention, and the following examples should not be read to limit, or define, the scope of the invention.

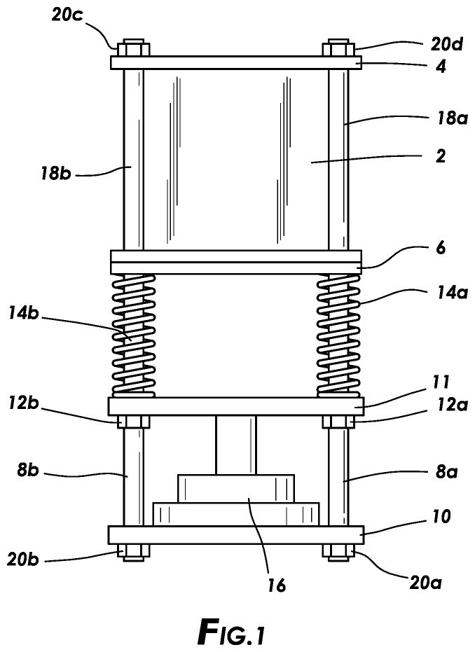

In one embodiment of the system as shown in FIG. 1 a solid oxide fuel cell stack (2) is disposed between and in contact with a fixed top compression plate (4) and a movable compression plate (6). The solid oxide fuel cell stack can be composed of any conventional solid oxide fuel cells, comprising an anode, electrolyte, cathode; and optionally an interconnect. The fixed top compression plate and movable compression plate can be made from metals or ceramics can be used at high temperatures. In a non-limiting embodiment, it is expected that the size of the fixed top compression plate and the movable compression plate are both larger than the size of the solid oxide fuel cell.

In one embodiment, at least one tension rod (8a and 8b) are inserted through an opening on a movable locking plate (11), wherein the top end of the tension rod is connected to the bottom of the movable compression plate and the bottom end of the tension rod is connected to a fixed bottom compression plate (10). The tension rod can be made from materials with high tensile strength such as metals that can be used at high temperatures. The fixed bottom compression plate can be made from metals or ceramics.

In one embodiment, at least one nut (12a and 12b) is used in conjunction with each tension rod and disposed below the movable locking plate to secure the movable locking plate in position. To facilitate the use of the nuts it is envisioned that the tension rods have screw threads located where the lock nuts are used. It is possible that the nut can either be two conventional nuts or a lock nut. Two conventional nuts may jammed together in place of a lock nut to secure the nut's position on the rod.

In one embodiment, at least one spring (14a and 14b ) is disposed around the at least one tension rod and connected to the bottom of the movable compression plate and the top of the fixed bottom compression plate.

In one embodiment, at least one pneumatic cylinder (16) can be in contact with the bottom of the movable locking plate and the fixed bottom compression plate.

In yet another embodiment, it is envisioned that the fixed top compression plate and the fixed bottom compression plate are connected with at least four rods (only two shown 18a and 18b), wherein the first rod is in contact with the bottom left front side of the fixed top compression plate and the top left front side of the fixed bottom compression plate, the second rod is in contact with the bottom right front side of the fixed top compression plate and the top right front side of the fixed bottom compression plate, the third rod is in contact with the bottom left back side of the fixed top compression plate and the top left back side of the fixed bottom compression plate, the fourth rod is in contact with the bottom right back side of the fixed top compression plate and the top right back side of the fixed bottom compression plate. To secure the rods to the fixed top compression plate and the fixed bottom compression plate, nuts or locking nuts can be used (20a, 20b, 20c, 20d). Alternatively, the top compression plate can have threaded holes that directly secure the tension rods.

In an alternate embodiment not shown, it is possible that the fixed top compression plate and the fixed bottom compression plate are connected with two rods. One at the center front side and the other at the center back side, or alternatively one at the center left side and one at the center right side.

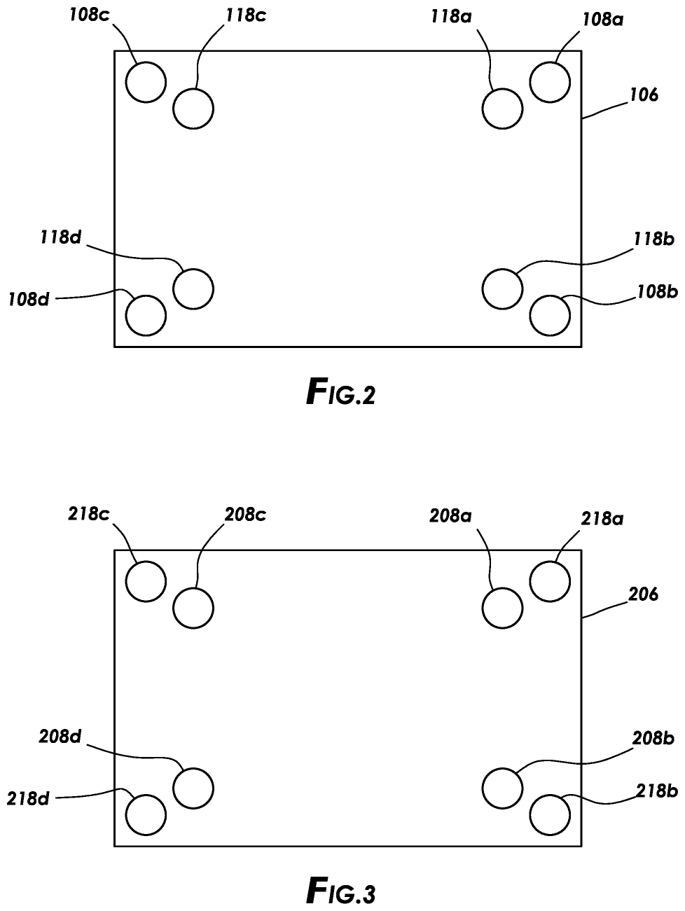

FIG. 2 depicts a cross sectional view of the system from a view from below the movable compression plate (106) looking up. In this embodiment, there are four tension rods (108a, 108b, 108c, and 108d) that are connected to the bottom movable compression plate on the outer edges of the movable compression plate. There are also four rods (118a, 118b, 118c, and 118d) that pass-through openings in the movable compression plate and are connected to the bottom of the fixed bottom compression plate and the top of the fixed top compression plate.

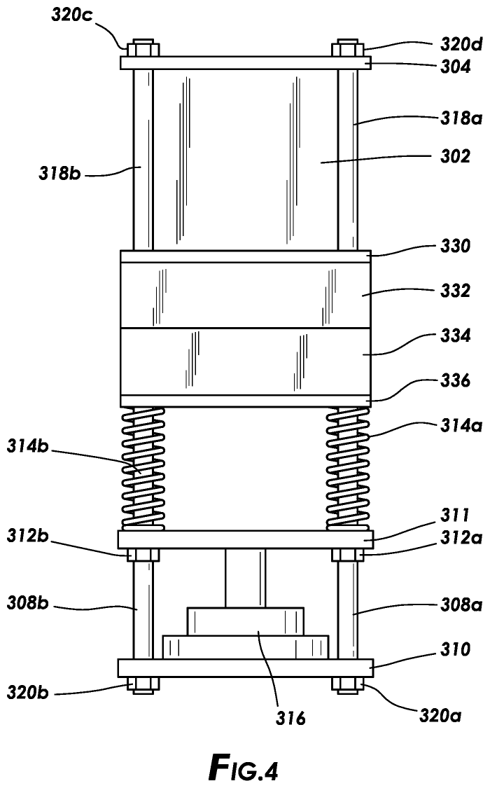

FIG. 3 depicts an alternate embodiment wherein it is a cross sectional view of the system from a view from below the movable compression plate (206) looking up. In this embodiment, there are four tension rods (208a, 208b, 208c, and 208d) that are connected to the bottom movable compression plate on the movable compression plate. There are also four rods (218a, 218b, 218c, and 218d) that pass-through openings on the outer edges in the movable compression plate and are connected to the bottom of the fixed bottom compression plate and the top of the fixed top compression plate.

In one embodiment of the system as shown in FIG. 4 a solid oxide fuel cell stack (302) is disposed between and in contact with a fixed top compression plate (304) and a bottom plate (330). The bottom plate is in contact and above a burner and/or heat exchanger (332) which is in contact and above an insulator (334). A movable compression plate (336) is below and in contact with the insulator. In this embodiment, at least one tension rod (308a and 308b) is inserted through an opening on a movable locking plate (311), wherein the top end of the tension rod is connected to the bottom of the movable compression plate and the bottom end of the tension rod is connected to a fixed bottom compression plate (310). The at least one lock nut (312a and 312b) is used in conjunction each tension rod and disposed below the movable locking plate to secure the movable locking plate in position. The at least one spring (314a and 314b) can be disposed around the at least one tension rod and connected to the bottom of the movable compression plate and the bottom of the fixed bottom compression plate. As shown in FIG. 3 at least one pneumatic cylinder (316) can be in contact with the bottom of the movable locking plate and the fixed bottom compression plate. Also shown in FIG. 4 are rods (308a and 308b) that are connected to the fixed top compression plate and the fixed bottom compression plate. In this embodiment there can be four rods (only two are shown in FIG. 4), the first rod is in contact with the bottom left front side of the fixed top compression plate and the top left front side of the fixed bottom compression plate, the second rod is in contact with the bottom right front side of the fixed top compression plate and the top right front side of the fixed bottom compression plate, the third rod is in contact with the bottom left back side of the fixed top compression plate and the top left back side of the fixed bottom compression plate, the fourth rod is in contact with the bottom right back side of the fixed top compression plate and the top right back side of the fixed bottom compression plate. To secure the rods to the fixed top compression plate and the fixed bottom compression plate nuts or locking nuts can be used (20a, 20b, 20c, 20d)

In yet another embodiment, it is envisioned since a burner and/or heat exchanger is directly below the bottom plate and above the insulator, the hot zone for this system comprises the area from the burner and/or heat exchanger to the fixed top compression plate. One advantage of having the hot zone in this area is that items such as the spring or pneumatic cylinder of the hot zone. Areas where excess heat can cause the spring or pneumatic cylinder. Additional spaces can also be placed between the spring and the bottom plate to further distance the springs and the pneumatic cylinder from the hot zone.

In one embodiment, the same compression method can be applied to a circular solid oxide fuel cell stack. The tension rods can be spaced around the perimeter at regular angular distance.

In one embodiment, the same compression method can be applied to an annular solid oxide fuel cell stack. The tension rods can be spaced around the perimeter at regular angular distance and/or at the center of the solid oxide fuel cell stack in the unoccupied space. In the instance of using a tension rod at the center of the solid oxide fuel cell stack, a single tension rod can improve the likelihood of evenly distributing the compressive force. In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A system comprising:
a solid oxide fuel cell stack disposed between and in contact with a fixed top compression plate and a movable compression plate;
at least one tension rod inserted through an opening on a movable locking plate, wherein the top end of the tension rod is connected to the bottom of the movable compression plate and the bottom end of the tension rod is connected to a fixed bottom compression plate;
at least one nut used in conjunction each tension rod and disposed below the movable locking plate to secure the movable locking plate in position;
at least one spring disposed around the at least one tension rod and connected to the bottom of the movable compression plate and the top of the fixed bottom compression plate; and
at least one pneumatic cylinder in contact with the bottom of the movable locking plate and the fixed bottom compression plate.

2. The system of claim 1, wherein the fixed top compression plate and the fixed bottom compression plate are connected with at least four rods, wherein the first rod is in contact with the bottom left front side of the fixed top compression plate and the top left front side of the fixed bottom compression plate, the second rod is in contact with the bottom right front side of the fixed top compression plate and the top right front side of the fixed bottom compression plate, the third rod is in contact with the bottom left back side of the fixed top compression plate and the top left back side of the fixed bottom compression plate, the fourth rod is in contact with the bottom right back side of the fixed top compression plate and the top right back side of the fixed bottom compression plate.

3. The system of claim 1, wherein there are four tension rods inserted through four separate openings on the movable locking plate, wherein the four separate openings are located on the left front side of the movable locking plate, the left back side of the movable locking plate, the right front side of the movable locking plate, and the right back side of the movable locking plate.

4. The system of claim 1, wherein the at least one pneumatic cylinder is engaged to provide upward vertical pressure on the movable locking plate which compresses the at least one spring upward to provide upward vertical pressure on the movable compression plate, which would allow the at least one lock nut to be screwed upwards and secured in contact with the bottom of the movable locking plate.

5. A system comprising:
a solid oxide fuel cell stack disposed between and in contact with a fixed top compression plate and a movable compression plate;
four tension rods inserted through four separate openings on a movable locking plate, wherein the four separate openings are located on the left front side of the movable locking plate, the left back side of the movable locking plate, the right front side of the movable locking plate, and the right back side of the movable locking plate and wherein the four tension rods are connected to the bottom of the movable compression plate and each bottom end of the four tension rods are connected to a fixed bottom compression plate;
at least one nut used in conjunction with each tension rod and disposed below the movable locking plate to secure the movable locking plate in position;
at least one spring disposed around each tension rod and connected to the bottom of the movable compression plate and the bottom of the fixed bottom compression plate;
at least one pneumatic cylinder in contact with the bottom of the movable locking plate and the fixed bottom compression plate
wherein the fixed top compression plate and the fixed bottom compression plate are connected with at least four rods, wherein the first rod is in contact with the bottom left front side of the fixed top compression plate and the top left front side of the fixed bottom compression plate, the second rod is in contact with the bottom right front side of the fixed top compression plate and the top right front side of the fixed bottom compression plate, the third rod is in contact with the bottom left back side of the fixed top compression plate and the top left back side of the fixed bottom compression plate, the fourth rod is in contact with the bottom right back side of the fixed top compression plate and the top right back side of the fixed bottom compression plate.
